(19) United States
(12) Patent Application Publication
(10) Pub. No.: US 2007/0088561 A1
(43) Pub. Date: Apr. 19, 2007

(54) System and method for developing a proposal

(75) Inventor: Elizabeth Ann Zeibig, Saint Louis, MO (US)

Correspondence Address: SAINT LOUIS UNIVERSITY;OFFICE OF INNOVATION AND INTELLECTUAL PROPERTY, 3556 CAROLINE MALL, SUITE C208, ST. LOUIS, MO, 63104, US

(73) Assignee: Saint Louis University

(21) Appl. No.: 11/251,040

(22) Filed: Oct. 17, 2005

(51) Int. Cl. G09B 25/00; G06Q 99/00

(52) U.S. Cl. 705/1; 434/365

(57) ABSTRACT

The invention is a computer-based system and method for developing a proposal, such as a grant or contract proposal, more preferably a laboratory management contract proposal. It provides an opportunity for individuals to apply concepts and hone proposal drafting skills that they have otherwise learned but need additional experience or practice to develop. The invention may be used as a teaching tool, but the inventor envisions the invention also being used in a commercial setting where proposal development is required. A preferred field in which this invention may be used as a teaching tool or in commercial competition is the field of laboratory management. The system comprises a CPU, a plurality of client computers, and a plurality of teams, wherein each team inputs a proposal into a client and the proposal is made available to another team on the CPU. The method comprises providing a set of instructions to a plurality of teams, each team collaborating to create a proposal satisfying the set of instructions, submitting a proposal to a supervisor, and making a proposal available to every team.

### BACKGROUND OF THE INVENTION

1. Field of the Invention

This invention relates generally to a computer-based system and method for developing a proposal, such as a grant proposal or contract proposal. Specifically, the invention relates to the application of laboratory management knowledge to develop a medical testing laboratory contract proposal bid.

2. Description of the Related Art

### Teaching Process

The teaching process involves one who is learned in a particular field to develop a curriculum to pass on his or her knowledge and experience to those who are less knowledgeable or experienced. Traditionally, a teacher instructs students via a lecture. The teaching process, although commonly associated only with schools, occurs in many aspects of modern society, including day-to-day commercial activities. Teachers often seek to enhance their teachings to make the process more efficient and effective. Teachers seek to help students learn more, faster, with a deeper understanding.

There are many ways to enhance the teaching process with technology. Most of them employ communication, research, graphic organization, presentation, or any combination of these four activities. Computers were originally thought to be programming tools only useful for the technically inclined. Later, it was thought that computers would replace teachers and all that was needed was really good software. But experience has taught that this just is not so. Computer Assisted instruction was explored over many years, not always successfully. Many software developers directed their production towards the home market producing what has come to be called “edu-tainment” software. Highly graphic and interactive in nature, it filled the role of supervised drill and practice but it often developed spontaneous rather than reflective thinking. It was difficult to justify the cost when weighed against the shallow depth of learning taking place. (Reference 5).

Skilled use of technology in the teaching process should increase student interest and motivation in the subject matter. It may also provide opportunities to students that would otherwise be unavailable, such as long distance learning or communication across language barriers. A student's use of technology to learn a particular subject matter, may also increase that student's knowledge and experience with technology, which may enhance that student's ability to use future technology to learn other material.

### Examples of Integrating Technology in the Teaching Process

One way that technology has been incorporated in the teaching process is through a process pioneered by Judi Harris called telecollaborative projects. (See references 1-2, 6-12, 16, & 19). A telecollaborative project is a project that contains one or more of 18 specific activity structures. Students complete the designated project and may generate a final product depending on the specific project completed. The telecollaborative project design has great flexibility in the type of project participating students complete. Students from different sites communicate on via the Internet during the project and when appropriate, projects generated by participants are posted on the telecollaborative project site. Students from physically different locations may communicate electronically with each other, and with professional experts and mentors depending on the structure used, as they work through a specific telecollaborative project. Project developers/coordinators decide what the project results will be and how they will be shared with others. A telecollaborative project may be set up at any point within a specific course or program of study. It may be formative or summative in nature. In a telecollaborative project, unlike this invention, all of the information gathered is obtained online, students communicate with other participants electronically, and students are typically locked into predetermined time lines for project completion since students communicate with each from physically different locations.

A second way that technology has been incorporated in the teaching process is through a Bernie Dodge invention called WebQuest. (See references 3-4, 13-14, & 17-18). A WebQuest is an inquiry-oriented activity in which some or all of the information that learners interact with comes from resources on the internet, optionally supplemented with videoconferencing. A WebQuest poses a central question with optional ancillary questions. Answers to the questions may be orally presented by individual people or teams of people, however, mostly teams email or post to a website the answers that they develop. Students find most, if not all, information to complete WebQuest on the Internet. Students usually complete the WebQuest in groups. Each student typically assumes a role or specific area to research. Students often assume the role of a historical or professional researcher during the completion process. WebQuests are typically designed as a mechanism by which students use the Internet for learning in a formative way rather than summative (“endpoint”). The content in a WebQuest should relate to both previous and subsequent activities.

A third way that technology has been incorporated in the teaching process, which is very similar to the previously mentioned WebQuest, is a CaseQuest. (See reference 15). A CaseQuest consists of a real-life problem or dilemma It provides an opportunity to compare and contrast solutions combined with a WebQuest in which students participate on teams. Students find most, if not all, information to complete CaseQuest on the Internet. Students usually complete the CaseQuest in groups. Each student typically assumes a role or specific area to research. Students often assume the role of a historical or professional researcher during the completion process. Teams develop answers to the question(s) that may be posted to the CaseQuest website or sent to the other participants via e-mail.

Recent research indicates that different students learn in different ways. One teaching method may not achieve the same effectiveness if used on different students. For example, Neil Fleming and Charles Bonwell developed a learning preference questionnaire that helps to describe how one person may have different learning preferences than those of other persons. (See reference 20). VARK is an acronym associated with this research where a person's learning preference may be any one or combination of the following four categories: (1) Visual, (2) Aural/Auditory, (3) Read/Write, and (4) Kinesthetic. A learner will learn more efficiently if the new information is taught in his or her learning preference. As the number of learners that a teacher is trying to teach increases, the odds that every learner will have the same or similar VARK learning preferences decreases. If the teacher teaches enough learners such that all of the VARK learning preferences are represented, then the teacher should enhance his or her teachings for each of the VARK learning preferences. (See generally reference 20).

### Proposal Process

A proposal process is frequently used where a person, company or organization wishes to compete for the business of another. In the proposal process, one entity will initiate a competition for its future business in an effort to obtain the most advantageous economic situation and lowest prices. The entity establishes minimum criteria which must be met, and distributes them to several persons, companies, or organizations. The persons, companies, or organizations then compete for the future business of the entity. Each competitor develops a proposal, satisfying every criterion, and submits their proposal. The winning bid is usually contractually binding on both parties. The proposal process is commonly found throughout all areas of commerce and academia, including medicine. Specifically, medical laboratories frequently submit proposal bids in an effort to win a contract to provide a laboratory services to medical service providers.

Most Health Management Organizations (HMO's) have a goal of providing cost efficient health services. To achieve this goal, an HMO will commonly request bid proposals for services it knows it will require. The services that an HMO may request bid proposals for may include construction, janitorial, maintenance, administration, laboratory tests, or any other service that the HMO may require. In one frequently experienced example, an HMO requests bid proposals from medical testing laboratories to provide future laboratory services to its present and future patients. The HMO will describe the medical laboratory testing services that it believes may be required. Any laboratory wishing to compete for the HMO's business will prepare a medical laboratory contract proposal describing which services it can provide to the HMO and at what cost. These services often include medical tests such as Complete Blood Count (CBC); Prothrombin Time (PT) and Partial Thromboplastin Time (PTT); Basic Chemistry Panel consisting of: Sodium (Na), Chloride (Cl), Blood Urea Nitrogen (BUN), Creatinine, Calcium (Ca), Potassium (K), Carbon Dioxide (CO2), Glucose, and others; and Blood Type and Antibody Screen. The HMO will then award its future business to the laboratory that submitted a winning proposal. A winning proposal is selected based on any number of factors. Usually, one of the most important factors in selecting a winning proposal is low cost. However, other factors, such as breadth and depth of possible services offered or reputation are frequently considered as well.

### Need to Integrate

During a proposal process, a person or team may be asked to develop a proposal on behalf of a competing group or organization, without having much experience at developing a proposal. Such persons or teams have long felt a need for help to develop a proposal. Similarly, students have a long felt need for being taught how to develop a proposal. This invention seeks to meet these long felt needs by providing a computer-based system and method for developing a proposal which may also be used to teach proposal development. A preferred embodiment of the invention enhances the proposal teaching process by using technology to teach to each of the four VARK learning preferences, thereby providing an efficient teaching method for all learners.

### REFERENCES

The following references are cited by number throughout this disclosure. Applicant makes no statement, inferred or direct, regarding the status of these references as prior art. Applicant reserves the right to challenge the veracity of statements made in these references, which are incorporated herein by reference.
1. Buss, Alan Richard (1998). An analysis of the essential elements and obstacles to conducting successful educational collaborative telecommunications projects across multiple sites (educational telecommunications, collaboration). Dissertation Abstracts International, 59-06, 1885.
2. Develop a Telecollaboration. [On-line]. (July, 2005). Available: http://nschubert.home.mchsi.com/education/eddevelop.html.
3. Dodge, Bernie. Active Learning of the Web (K-12 Version). [On-line]. (July, 2005). Available: http://edweb.sdsu.edu/people/bdodge/active/ActiveLearningk-12.html.
4. Dodge, Bernie (1997). Some Thoughts About WebQuests. [On-line]. (July, 2005). Available: http://webguest.sdsu.edu/about_webquests.html.
5. Enhance Learning with Technology (2002). [On-line]. (July, 2005). Available: http://www.enhancelearning.ca/.
6. Harris, Judi (1995). Organizing and Facilitating Telecollaborative Projects. The Computing Teacher, 22(5), 66-69.
7. Harris, Judi (1995). Educational Telecomputing Projects: Interpersonal Exchanges. The Computing Teacher, 22(6).
8. Harris, Judi (1995). Educational Telecomputing Projects: Information Collections. The Computing Teacher, 22(7).
9. Harris, Judi (1995). Educational Telecomputing Activities: Problem-Solving Projects. Learning and Leading With Technology, 22(8).
10. Harris, Judi (1997). Wetware: Why Use Activity Structures? Learning and Leading With Technology, 26(1), 6-14.
11. Harris, Judi (1998). Curriculum-Based Telecollaboration. Using Activity Structures to Design Student Projects. Learning and Leading With Technology, 26(1), 6-15.
12. Harris, Judi (2001). Teachers as telecollaborative project designers: A curriculum-based approach. Contemporary Issues in Technology and Teacher Education, [online serial], 1(3). Available: http://www.citejournal.org/vol1/iss3/seminal/article1.htm
13. Key Elements of a WebQuest. [On-line]. (July, 2005) Available: http://www.thematzats.con/webquests/page3.html.
14. March, Tom (1998). Why WebQuests?, and introduction. [On-line]. (July, 2005). Available: http://www.ozline.com/webquests/intro.html.
15. Pretti-Frontczak, K., Brown, T., and J. Walsh (2005). A Preliminary Investigation of the Effectiveness of CaseQuests in Preparing Family-Guided and Technologically-Competent Early Childhood Interventionists. Journal of Computing in Teacher Education, 21(3), 87-93.
16. Project Basics—Judi Harris's Activity Structures. [On-line]. (July, 2005). Available: http://www.2learn.ca/Projects/Together/structures.html.
17. WebQuest. [On-line]. (July 2005). Available: http://en.wikipedia.org/wiki/Webquest.
18. Webquest 101—Putting Discovery into the Curriculum. [On-line]. (July, 2005). Available: http://www.teachersfirst.com/summer/webquest/quest-a.shtml.
19. Wheatcroft, Mavis Dianne (2002). Considerations for developing successful telecollaborative learning experiences. Masters Abstracts International, 41-05, 1264.
20. VARK Leaning Styles. [On-line]. (July 2005). Available: http://www.vark-learn.com/english/index.asp

### SUMMARY OF THE INVENTION

The invention is a method and system for developing a proposal, such as a grant or contract proposal, more preferably a laboratory management contract proposal. It provides an opportunity for individuals to apply concepts and hone proposal drafting skills that they have otherwise learned but need additional experience or practice to develop. Preferably, the invention may be used as a teaching tool, but the inventor envisions the invention also being used in a commercial setting where proposal development is required. A preferred field in which this invention may be used as a teaching tool or in commercial competition is the field of laboratory management.

In one embodiment, the invention is drawn to a computer-based system for proposal development. The system contains a plurality of teams, one or more computer clients, and at least one server. A client is connected to the server via some electronic communication means, e.g., the internet, an intranet, a network, or the like. Each team generates and inputs a proposal to a client, thereby making the proposal available on the server for another team to access through a client; which is a preferred mechanism of information exchange between the teams. Preferably, a team has two or more members, who work together to prepare the proposal; more preferably a team has 2 to 10 members; most preferably a team has 2 to 4 members. In one aspect, the system is used in an educational setting, whereby the preferred team contains at least one student. In a preferred aspect, the system is used to apply and hone laboratory management contract proposal skills. The posting of all of the proposals serves as the primary mechanism for information exchange allowing participants to see how the various teams, potentially from different geographic regions, approached the project.

Optionally, a team is restricted access to a proposal that has been made available on the CPU until after the team has submitted a proposal. Under this option, a team gains access to another proposal only after the team has submitted a proposal to the CPU.

The system may be used to produce a proposal—e.g., as in a commercial setting, and/or to teach proposal development—e.g., as in an educational setting. However, one skilled in the art in practicing this invention, may find other utilities for this invention.

In a second embodiment, the invention is drawn to a method for proposal development. The following steps comprise the method. A set of instructions is provided to a plurality of teams, wherein each team is asked to generate a proposal with a plurality of elements. A team collaborates to research each required element of a proposal. Each team works independently of every other team. Each team creates a proposal and preferably submits it to a supervisor. Each proposal is made available to every other team. In a preferred aspect of this embodiment, the instant computer-based system for proposal development (supra) is employed.

This second embodiment optionally includes the additional step of a team presenting to one or more other teams a proposal in the form of an audio visual presentation. Additionally, each proposal may be compared to one or more other proposals, one proposal may be selected as being superior, and the team that submitted the superior proposal may be notified of that selection. The team that has submitted the superior proposal may be rewarded.

The method may be used to produce a proposal—e.g., as in a commercial setting, and/or to teach proposal development—e.g., as in an educational setting. However, one skilled in the art in practicing this invention, may find other utilities for this invention.

### BRIEF DESCRIPTION OF THE DRAWINGS

FIG. 1 depicts a flow diagram of the computer network system for developing a proposal.

FIGS. 2-7 depict screen shots of six linked web pages that, together, operate as an example of the invention.

FIG. 2 depicts the opening screen shot on a client monitor. This page contains the title of a project that is an example of the invention.

FIG. 3 depicts a screen shot of a second web page on a client monitor, entitled “Project Background,” providing a portion of the invention's set of instructions in this example.

FIG. 4 depicts a screen shot of a third web page on a client monitor, entitled “The Project,” providing an additional portion of the invention's set of instructions and describing elements required of a proposal in this example.

FIG. 5 depicts a screen shot of a fourth web page on a client monitor, entitled “Project Logistics,” providing an additional portion of the invention's set of instructions and describing different possible roles for participants to assume in this example.

FIG. 6 depicts a screen shot of a fifth web page on a client monitor, entitled “Project Organizer: Contact Information.”

FIG. 7 depicts a screen shot of a sixth web page on a client monitor, entitled “Directions for Joining the Project.”

### DETAILED DESCRIPTION OF A PREFERRED EMBODIMENT OF THE INVENTION

The invention provides a computer network system and method for developing a proposal, preferably a grant or contract proposal, more preferably a laboratory management contract proposal. The invention may also be used as a system and method for teaching proposal development, preferably for teaching laboratory management contract proposal development.

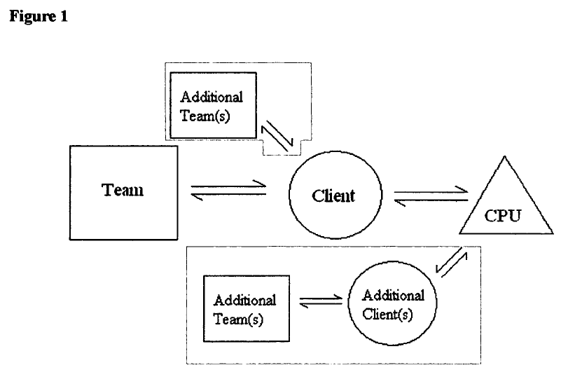

In accordance with the invention, FIG. 1 illustrates a computer network system for developing a proposal. The system comprises a plurality of teams, one or more computer clients, and at least one CPU. A client is connected to a CPU via an electronic communication means such that a client may access information that is made available on the CPU. Although a minimum of one client is used to access the CPU, the actual number of clients coupled to the CPU does not affect the invention. Potentially, any number of clients could be coupled to the CPU in the practice of this invention. A client may be a personal computer. The CPU may be a remote server.

A team interfaces with a client to input a proposal. A proposal that has been inputted into a client is made available on the CPU to a client that is connected to the CPU via an electronic communication means. A team may access any proposal that has been made available on the CPU from any connected client. Preferably, a team has two or more members, who work together to prepare the proposal; more preferably a team has 2 to 10 members; most preferably a team has 2 to 4 members. In a preferred aspect, where the system is used to teach proposal development, at least one team member is a student. A team may be given a timeframe within which to work or a deadline by which the proposal must be inputted into a client and made available on the CPU.

Optionally, a supervisor may interface with a client to input a set of instructions outlining required elements of a proposal, making the set of instructions available on the CPU. A team may access the set of instructions that has been made available on the CPU from any connected client. The set of instructions may include a scenario which is completely or partially fictitious, or completely based on reality.

Optionally, a team is restricted access to a proposal that has been made available on the CPU until after the team has submitted a proposal. A team gains access to a proposal only after the team has inputted a proposal into a client, making it available on the CPU.

This computer network system may be used as a tool to aid in proposal development or as a teaching tool to teach proposal development.

A second embodiment of this invention involves a method for developing a proposal. The following steps comprise the method. A set of instructions is provided to a plurality of teams, wherein each team is asked to generate a proposal with a plurality of elements. A team collaborates to research every required element of a proposal. Each team works independently of every other team. Each team creates a proposal and submits it to a supervisor. Each proposal is made available to every other team. This method may be used as a tool for proposal development or as a teaching tool to teach proposal development.

Preferably, a team has two or more members, who work together to prepare the proposal; more preferably a team has 2 to 10 members; most preferably a team has 2 to 4 members. In a preferred aspect, where the system is used to teach proposal development, at least one team member is a student. A team may collaborate such that at least two team members work together on an element of the proposal or a team may collaborate such that no two team members work together on any element of the proposal. A team may be given a timeframe within which to work or a deadline by which the proposal must be submitted. If the proposal is to be made available to other teams via the server, then the proposal must be submitted electronically. A team may submit a proposal to the supervisor via an audio visual presentation, e.g. PowerPoint Presentation or formal oral presentation.

The set of instructions must set forth the required elements of a proposal. In the case where the invention is directed to the education of students engaged in learning to develop a laboratory management contract proposal, the required elements comprise (a) a cost-benefit analysis, (b) an organizational structure chart, (c) a marketing brochure, and (d) a determination of possible value-added services currently permitted by law. The set of instructions may include a scenario which is completely or partially fictitious, or completely based on reality.

Optionally, this method for proposal development may include the additional steps of comparing the proposals, selecting one of the proposals as superior to another proposal, and notifying a team which proposal is the winning proposal. Another optional additional step includes rewarding the team that submitted the winning proposal. The team submitting the winning proposal may be awarded in any way, preferably monetarily, academically (e.g. with a superior classroom grade), or verbally.

In accordance with the invention, one preferred aspect involves a computer network system (FIG. 1) and method for teaching laboratory management contract proposal development. For example, the inventor envisions using the invention as an aid for teaching laboratory management contract proposal development in a classroom setting, potentially spanning various different geographic regions.

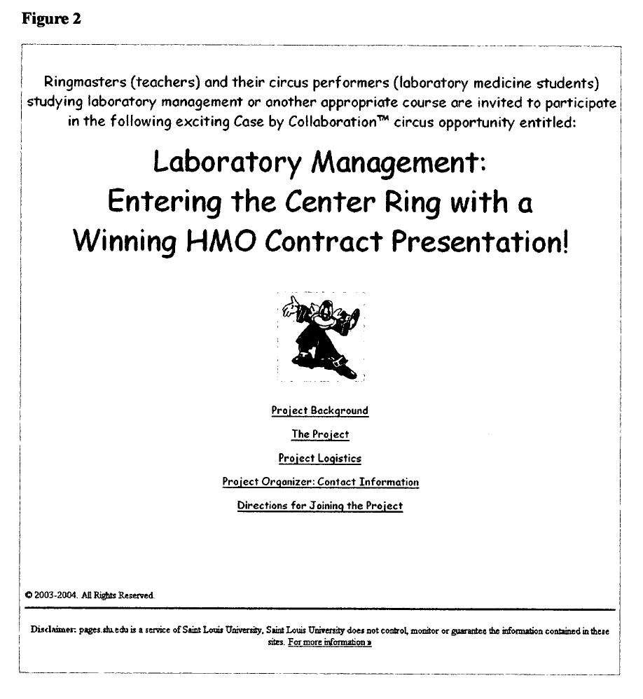

One example of the invention includes an internet website, created by the inventor, which contains a plurality of linked web pages. The website, including all of the linked web pages, comprises the invention's set of instructions. FIG. 2 is a screen shot of the opening web page. The opening web page invites teachers and laboratory medicine students to use the website. The opening page also has a title which briefly describes the field within which the invention operates on the website, namely, “Laboratory Management.” The title also briefly describes the goal of the website, namely, “a winning HMO Contract Presentation.” The opening page also has graphics and a list of links to the other pages that make up the website as a whole.

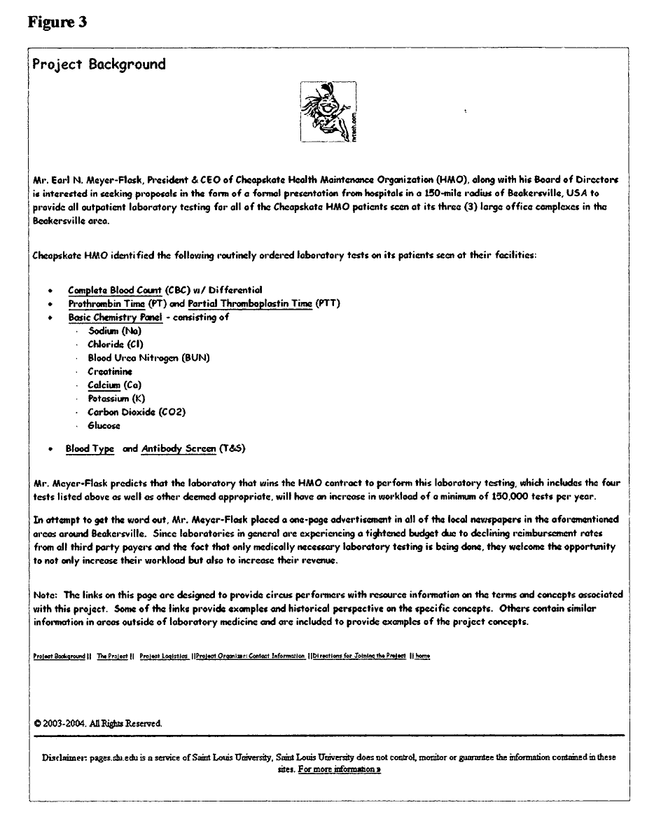

FIG. 3 is a screen shot of a second web page entitled, “Project Background.” This page is a portion of the invention's set of instructions. This page sets forth a fictitious scenario where a large HMO is seeking contract proposals for future medical laboratory business. This page also describes several common laboratory tests that are routinely ordered by the fictitious HMO. The laboratory tests are real tests commonly ordered in the medical community. Therefore, this page also contains links to other, third party web pages that describe these tests in greater detail. The links on this page are designed to provide participants with resource information on the terms and concepts associated with this example. Some of the links provide illustrations and historical perspective on the concepts and terms specific to this example, i.e. laboratory management contract proposal development. Other links provide illustrations and historical perspective on terms and concepts outside of the field of laboratory management contract proposal development and are included to provide illustration of the concepts and terms specific to this example.

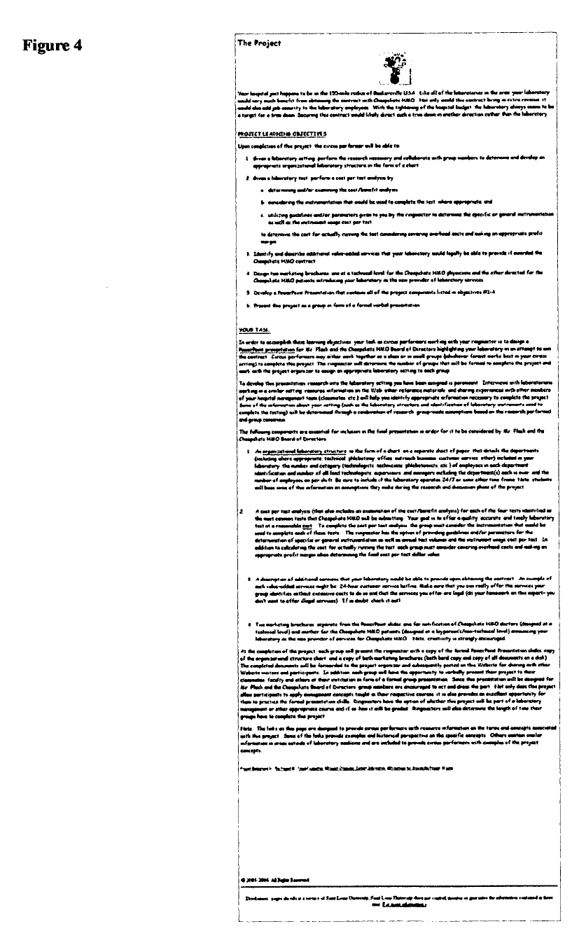

FIG. 4 is a screen shot of a third web page entitled, “The Project.” This page articulates learning objectives that will be accomplished by completing the project. Use of the invention in this example aids a participant to learn to research and collaborate with group members to determine and develop an appropriate organizational laboratory structure in the form of a chart; perform a cost per test analysis to determine the cost for actually running a test considering overhead costs and appropriate profit margins; identify and describe additional value-added services that a laboratory could legally provide; design two marketing brochures; develop a PowerPoint Presentation; and present a proposal, as a group, in the form of a formal oral presentation. In this example, a cost per test analysis asks the participant to determine/examine the cost/benefit analysis, consider the instrumentation that would be used to complete the test, and determine specific or general instrumentation needs as well as the instrument usage cost per test. Also, the two marketing brochures are envisioned to be designed for different audiences, one at a technical level for physicians and the other directed for patients, introducing a laboratory as a new provider of laboratory services.

The web page in FIG. 4 also defines required elements of a proposal in this example. A proposal in this example must include: (1) an organizational laboratory structure, in the form of a chart, on a separate sheet of paper, that details the departments (including where appropriate, technical, phlebotomy, office, outreach business, customer service, other) included in your laboratory, the number and category (technologists, technicians, phlebotomists, etc.) of employees in each department, identification and number of all lead technologists, supervisors, and managers including the department(s) each is over, the number of employees on per shift, and the operation time frame (i.e., does the lab operate 24/7, some other time frame? If so, what?); (2) a cost per test analysis (that also includes an examination of the cost/benefit analysis) for each of four tests identified as the most commonly ordered tests as described on the “Project Background” web page of this example (see FIG. 3); (3) a description of additional services that a laboratory would be able to provide upon winning the contract bid; and (4) two marketing brochures, one, designed at a technical level, for doctors and another for patients, designed at a non-technical level, announcing the participant's fictitious laboratory as a new provider of laboratory services. The example also requires that each proposal include the previously mentioned elements in a PowerPoint Presentation. Optionally, each group may be required to make a formal oral presentation incorporating the PowerPoint presentation and every other required element of a proposal.

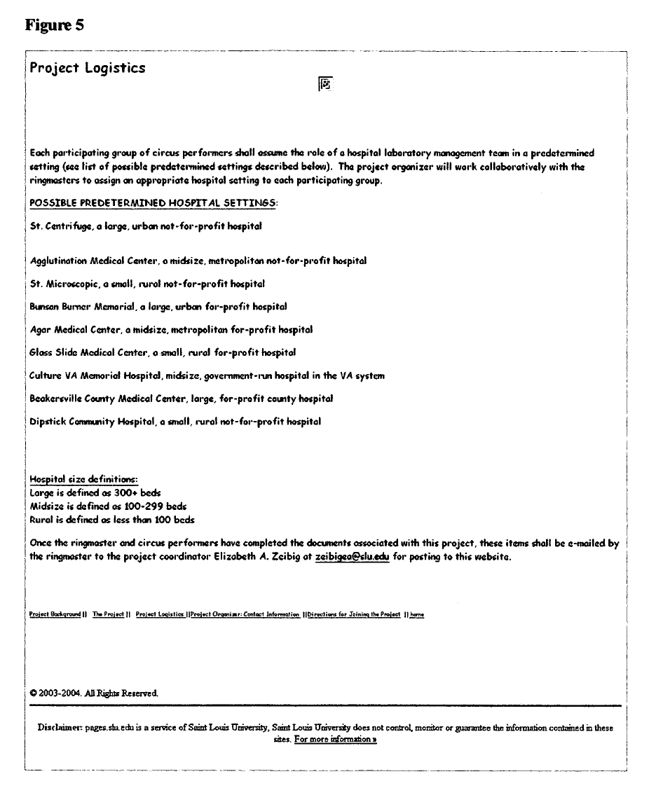

In this example, laboratory management students are assigned to a team. Each team is assigned a role as a fictitious hospital laboratory that has decided to submit a contract proposal to try to win the fictitious HMO's future medical laboratory business contract. FIG. 5 is a screen shot of a fourth web page entitled, “Project Logistics.” This web page describes a variety of different potential hospital settings that a team could be assigned to assume the role of. The potential hospital settings described on this web page include: an urban, not-for-profit hospital with 300 or more beds; a metropolitan not-for-profit hospital with 100-299 beds; a rural not-for-profit hospital with less than 100 beds; an urban for-profit hospital with 300 or more beds; a metropolitan for-profit hospital with 100-299 beds; a rural for-profit hospital with less than 100 beds; a government-run hospital in the VA system with 100-299 beds; a for-profit county hospital with 300 or more beds; and a rural not-for-profit hospital with less than 100 beds; however, other roles are possible.

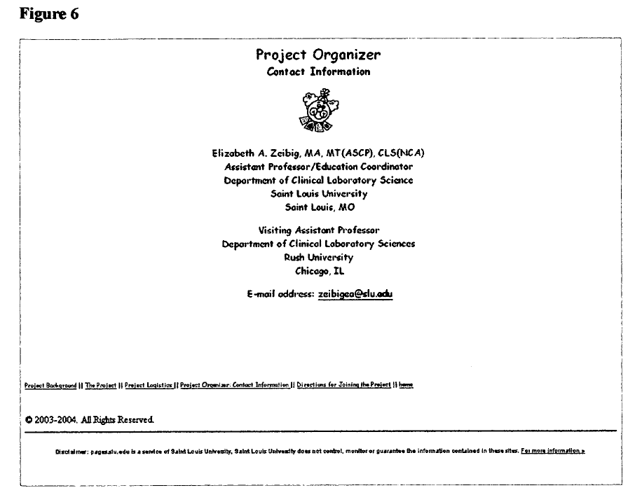

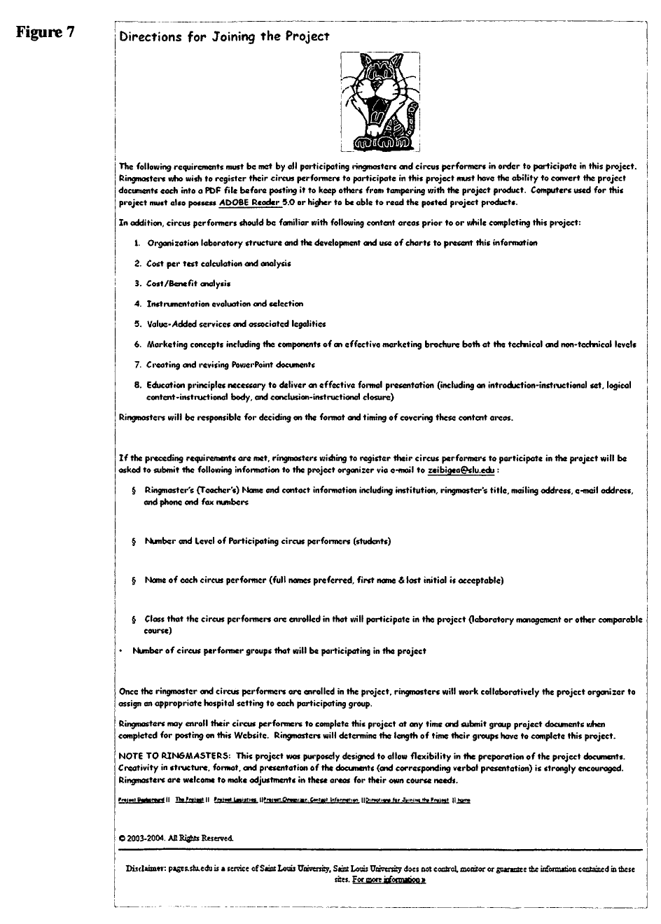

FIG. 6 is a screen shot of a fifth web page entitled, “Project Organizer: Contact Information,” which contains a preferred means to contact a Project Organizer. This contact information allows participants to contact the Project Organizer with any questions or comments. The contact information also describes the manner by which participants should submit a proposal. FIG. 7 is a screen shot of a sixth web page entitled, “Directions for Joining the Project,” which is an invitation for any person who wishes to participate to contact the Project Organizer and make the appropriate arrangements. This page also describes information that any potential participant should be familiar with before joining the project. In this example, a participant should be familiar with organization laboratory structure and the development and use of charts to present this information, cost per test calculation and analysis, cost/benefit analysis, instrumentation evaluation and selection, value-added services and associated legalities, marketing concepts including the components of an effective marketing brochure both at the technical and non-technical levels, creating and revising PowerPoint documents, and education principles necessary to deliver an effective formal presentation (including an introduction-instructional set, logical content-instructional body, and conclusion-instructional closure).

In this example, students work together in teams to develop a proposal. Each team of students submits a proposal, comprised of the elements described above and on the web page (FIG. 4). The teams email all of the components of a proposal to the Project Organizer. As each team submits a proposal, the Project Organizer makes the proposal available on the website for other teams to view. By viewing other proposals, a team may learn how other teams, potentially from various geographic regions, approached the project.

What is claimed is:

1. A computer network system for developing a proposal, the system comprising
a CPU,
at least one client coupled to the CPU, and
a plurality of teams;
wherein a team generates a proposal and inputs the proposal into a client such that the proposal is available on the CPU for another client or team to view.

2. The computer network system of claim 1, wherein the proposal is a laboratory management contract proposal.

3. The computer network system of claim 1, wherein the CPU is a remote server.

4. The computer network system of claim 1, wherein a team comprises at least two individuals.

5. The computer network system of claim 4, wherein at least one of the individuals is a student.

6. The computer network system of claim 1, wherein at least one client is a personal computer.

7. The computer network system of claim 1, wherein a team is restricted access to a proposal made available on the CPU until after the team has generated and inputted a proposal into a client such that the proposal inputted by the team is made available on the CPU for another team or client to view.

8. A computer network system for developing a laboratory management contract proposal, the system comprising a remote server, a plurality of personal computer clients coupled to the remote server, and a plurality of teams, each team comprising at least one student; wherein each team generates a laboratory management proposal and inputs the proposal into a personal computer client such that the proposal is available on the server for other personal computer clients and teams to view.

9. A method for developing a proposal comprising the steps of:
(a) providing a set of instructions to a plurality of teams, wherein the set of instructions requires each team to create a proposal with a plurality of elements;
(b) collaborating to research each element of the plurality of elements;
(c) creating a proposal containing each element; and
(d) making a proposal available to each and every team.

10. The method of claim 9, wherein the set of instructions includes elements directed to a laboratory management scenario, the elements comprising (a) a cost-benefit analysis, (b) an organizational structure chart, (c) a marketing brochure, and (d) a determination of possible value-added services currently permitted by law.

11. The method of claim 9, wherein at least one team comprises at least two team members.

12. The method of claim 11, wherein at least one of the team members is a student.

13. The method of claim 9, wherein the proposal is (a) inputted by a team into a client, (b) transmitted to a server, and (c) made available to other teams that can access the server through a client.

14. The method of claim 9, wherein a team presents a proposal to one or more other teams via an audio visual presentation.

15. The method of claim 11, wherein no two team members work together on any one element of the proposal.

16. The method of claim 11, wherein at least two team members work together on an element of the proposal.

17. The method of claim 9, further comprising the steps of:
(a) comparing the proposals, (b) selecting one of the proposals as superior to the other proposals, and (c) notifying the teams of which proposal is the winning proposal.

18. The method of claim 17, further comprising the step of rewarding the team that submitted the winning proposal.

19. A method for developing a laboratory management contract proposal comprising the steps of:
(a) a supervisor provides a laboratory management scenario to a plurality of teams, wherein
(i) the scenario comprises one or more required elements to be satisfied and requires each team to create a contract proposal that includes the one or more required elements, and
(ii) each team comprises at least two individuals, at least one of which is a student;
(b) the at least two individuals of a team collaborate to research each and every required element of the contract proposal;
(c) each team creates a contract proposal;
(d) each team submits the contract proposal to a server by inputting the contract proposal into a client that is operably linked to the server;
(e) once a team has submitted a contract proposal, then that team is granted access via the server to one or more contract proposals submitted by one or more other teams.
